(19) United States
(12) Patent Application Publication
(10) Pub. No.: US 2017/0034111 A1
(43) Pub. Date: Feb. 2, 2017

(54) Method and Apparatus for Determining Key Social Information

(71) Applicant: Huawei Technologies Co., Ltd., Shenzhen (CN)

(72) Inventors: Lifeng Shang, Hong Kong (HK); Jing Li, Hong Kong (HK); KamFai Wong, Hong Kong (HK)

(21) Appl. No.: 15/223,836

(22) Filed: Jul. 29, 2016

(30) Foreign Application Priority Data
Jul. 30, 2015 (CN) 201510458735.3

(51) Int. Cl. H04L 12/58

(52) U.S. Cl. CPC H04L 51/32; H04L 51/12

(57) ABSTRACT

A method and apparatus for determining key social information, comprises acquiring directly-retransmitted social information and indirectly-retransmitted social information of original social information, and establishing a social information retransmitting tree; acquiring an information characteristic of each piece of retransmitted social information in the social information retransmitting tree; determining a characteristic vector of each piece of retransmitted social information according to the information characteristic of the retransmitted social information; inputting the obtained characteristic vector into a preset filtering model, and acquiring candidate key social information; and selecting final key social information from all candidate key social information according to a criticality evaluation value of each piece of candidate key social information. In the technical solution of the present disclosure, directly-retransmitted social information and indirectly-retransmitted social information are comprehensively considered, and key social information is selected from all retransmitted social information of original social information, which improves accuracy of a selection result.

### CROSS-REFERENCE TO RELATED APPLICATION

This application claims priority to Chinese Patent Application No. 201510458735.3, filed on July 30, 2015, which is hereby incorporated by reference in its entirety.

### TECHNICAL FIELD

The present disclosure relates to the field of Internet technologies and the field of computer technologies, and in particular, to a method and apparatus for determining key social information.

### BACKGROUND

Among existing Internet applications, a social network has been widely applied and rapidly developed, such as microblog. In the social network, a social object (that is, a user) may publish information in various media forms, such as text, a picture, and a video, and may also browse information published by another social object. To facilitate communication between social objects, a relationship of following and being followed may be established between the social objects, and the social objects may browse social information presented by each other, and repost and comment on the social information.

After being published, one piece of social information can be retransmitted by another social user. The retransmitting process may be merely retransmitting the foregoing social information, or may be retransmitting the foregoing social information and at the same time expressing an opinion of the social user on the social information. It may be learned that one piece of original social information may be related to a large amount of retransmitted social information, and the retransmitted social information includes directly-retransmitted social information and indirectly-retransmitted social information, where the directly-retransmitted social information is information obtained after the original social information is retransmitted, and the indirectly-retransmitted social information is information obtained after the directly-retransmitted social information is retransmitted. When statistics about influence caused by one piece of original social information is collected, generally, the most representative retransmitted social information (that is, key retransmitted social information) needs to be selected from a large amount of retransmitted social information. The most representative retransmitted social information can characterize reaction of a great majority of social objects on information described in the original social information.

Currently, a method for determining the most representative retransmitted social information from retransmitted social information is extracting, from all directly-retransmitted social information, directly-retransmitted social information that is retransmitted the most times, and using the directly-retransmitted social information obtained by means of extraction as the most representative retransmitted social information; or acquiring social objects of all directly-retransmitted social information, extracting the most famous social object from all the acquired social objects, and using directly-retransmitted social information of the most famous social object as the most representative retransmitted social information. In the technical solution, only a characteristic of directly-retransmitted social information is considered. Therefore, the most representative retransmitted social information that is finally acquired is one-sided.

It may be learned that a problem of low selection result accuracy currently exists in a process of selecting key retransmitted social information from retransmitted social information.

### SUMMARY

Embodiments of the present disclosure provide a method and apparatus for determining key social information, to resolve a problem of low selection result accuracy currently existing in a process of selecting key retransmitted social information from retransmitted social information.

A specific technical solution provided in the embodiments of the present disclosure is as follows.

According to a first aspect, the present disclosure provides a method for determining key social information, including generating a social information retransmitting tree according to to-be-determined original social information and retransmitted social information of the original social information, where the retransmitted social information comprising information indicating directly or indirectly retransmission of the original social information, the social information retransmitting tree is of a tree-like structure, the original social information is a root node in the tree-like structure, and the retransmitted social information is a leaf node in the tree-like structure and an intermediate node between the root node and the leaf node; acquiring a characteristic vector of each piece of retransmitted social information according to an information characteristic of each piece of retransmitted social information, where the information characteristic includes a text characteristic and a characteristic associated with the social information retransmitting tree, and the character vector of each piece of retransmitted social information includes a vector that represents the text characteristic of the retransmitted social information and a vector that represents the characteristic that is of the retransmitted social information and that is associated with the social information retransmitting tree; inputting the characteristic vector of each piece of retransmitted social information into a preset filtering model, and acquiring candidate key social information included in all retransmitted social information; calculating a criticality evaluation value corresponding to each piece of candidate key social information; and selecting a preset amount of candidate key social information in descending order of criticality evaluation values from all candidate key social information, and determining the selected candidate key social information as the key social information.

With reference to the first aspect, in a first possible implementation manner of the first aspect, the acquiring a characteristic vector of each piece of retransmitted social information according to an information characteristic of each piece of retransmitted social information includes performing the following operations for any piece of retransmitted social information in the social information retransmitting tree: extracting a text characteristic of the any piece of retransmitted social information from content of the any piece of retransmitted social information, converting each characteristic amount included in the text characteristic of the any piece of retransmitted social information into a characteristic amount in a numerical value form by using a preset algorithm, and acquiring, according to all characteristic amounts in a numerical value form, a text characteristic vector corresponding to the any piece of retransmitted social information; acquiring, according to location information of a node represented by the any piece of retransmitted social information in the social information retransmitting tree and/or a quantity of nodes in the social information retransmitting tree that are brother nodes of the node represented by the any piece of retransmitted social information, a characteristic vector that is corresponding to the any piece of retransmitted social information and associated with the social information retransmitting tree; and combining the text characteristic vector and the characteristic vector associated with the social information retransmitting tree, to acquire a characteristic vector of the any piece of retransmitted social information, where the combination processing is performing up-and-down combination on the text characteristic vector and the characteristic vector associated with the social information retransmitting tree, or performing left-and-right combination on the text characteristic vector and the characteristic vector associated with the social information retransmitting tree.

With reference to the first aspect or the first possible implementation manner of the first aspect, in a second possible implementation manner, a method for generating the filtering model includes acquiring training retransmitted social information of any piece of training original social information from historical data; generating a characteristic vector of each piece of training retransmitted social information according to an information characteristic of each piece of training retransmitted social information, where the characteristic vector of each piece of training retransmitted social information includes a vector that represents a text characteristic of the training retransmitted social information and a vector that represents a characteristic that is of the training retransmitted social information and that is associated with the social information retransmitting tree; acquiring a filtering parameter by using a preset filtering algorithm according to the characteristic vector of each piece of training retransmitted social information and a known filtering and classification result of each piece of training retransmitted social information; and generating the filtering model according to the filtering parameter.

With reference to the first possible implementation manner or the second possible implementation manner of the first aspect, in a third possible implementation manner, the acquiring a filtering parameter by using a preset filtering algorithm according to the characteristic vector of each piece of training retransmitted social information and a known filtering and classification result of each piece of training retransmitted social information includes acquiring the filtering parameter by using a support vector machine algorithm according to the characteristic vector of each piece of training retransmitted social information and the known filtering and classification result of each piece of training retransmitted social information; or acquiring the filtering parameter by using a perceptron neural network algorithm according to the characteristic vector of each piece of training retransmitted social information and the known filtering and classification result of each piece of training retransmitted social information; or generating an input sequence according to the characteristic vector of each piece of training retransmitted social information and a retransmitting relationship between the pieces of training retransmitted social information, generating an output sequence according to the known filtering and classification result of each piece of training retransmitted social information, establishing a correlation function between the input sequence and the output sequence, determining a parameter of the correlation function according to the known filtering and classification result of each piece of training retransmitted social information, and determining the parameter as the filtering parameter.

With reference to the third possible implementation manner of the first aspect, in a fourth possible implementation manner, the establishing a correlation function between the input sequence and the output sequence includes establishing a table of a link relationship between the input sequence and the output sequence according to a retransmitting relationship between training characteristic vectors included in the input sequence and a relationship between each training characteristic vector included in the input sequence and each filtering and classification result included in the output sequence; performing the following operations for any training characteristic vector in the input sequence: scanning the table of the link relationship by using a window of a preset width, where a currently scanned window includes the any vector, generating a first partial correlation function according to a filtering and classification result in the output sequence and the any training characteristic vector that are included in the currently scanned window, and generating a second partial correlation function according to the filtering and classification result in the output sequence that is included in the currently scanned window; and establishing the correlation function between the input sequence and the output sequence according to a first partial correlation function and a second partial correlation function that are corresponding to each vector included in the input sequence.

With reference to the first aspect or any one of the first possible implementation manner to the fourth possible implementation manner of the first aspect, in a fifth possible implementation manner, the calculating a criticality evaluation value corresponding to each piece of candidate key social information includes constructing a candidate key social information diagram according to the candidate key social information, where the key social information diagram includes all the candidate key social information, and every two pieces of candidate key social information are connected to each other; and for any piece of candidate key social information in the candidate key social information diagram, acquiring a value of a correlation between the any piece of candidate key social information and each of other pieces of candidate key social information, and determining, according to the value of the correlation between the any piece of candidate key social information and each of the other pieces of candidate key social information in the candidate key social information diagram, a criticality evaluation value corresponding to the any piece of candidate key social information.

With reference to the fifth possible implementation manner of the first aspect, in a sixth possible implementation manner, the criticality evaluation value meets the following formula:

$${R}_{t} ( v ) = λ {R}_{0} ( v ) + ( 1 - λ ) {\sum }_{i = 0}^{i = n} \frac{p ( {u}_{i} \to v ) {R}_{t - 1} ( v )}{{Z}_{t - 1} ( u )} ,$$

where Rₜ(v) is a criticality evaluation value obtained after the t^{th} iteration, λ is a preset coefficient, R₀(v) is a quantity of times candidate key social information v is retransmitted, n is a quantity of candidate key social information associated with the candidate key social information v in the candidate key social information diagram, Rₜ₋₁(v) is a criticality evaluation value obtained after the (t−1)^{th} iteration, p(uᵢ→v) ) is a value of a correlation between candidate key social information uᵢ, associated with the candidate key social information v and the candidate key social information v, and

$${Z}_{t - 1} ( u ) = {\sum }_{i = 0}^{i = n} p ( {u}_{i} \to v ) {R}_{t - 1} ( v ) .$$

According to a second aspect, an apparatus for determining key social information is provided, including a social information retransmitting tree generation unit configured to generate a social information retransmitting tree according to to-be-determined original social information and retransmitted social information of the original social information, where the retransmitted social information comprising information indicating directly or indirectly retransmission of the original social information, the social information retransmitting tree is of a tree-like structure, the original social information is a root node in the tree-like structure, and the retransmitted social information is a leaf node in the tree-like structure and an intermediate node between the root node and the leaf node; a characteristic vector acquiring unit configured to acquire a characteristic vector of each piece of retransmitted social information according to an information characteristic of each piece of retransmitted social information, where the information characteristic includes a text characteristic and a characteristic associated with the social information retransmitting tree, and the character vector of each piece of retransmitted social information includes a vector that represents the text characteristic of the retransmitted social information and a vector that represents the characteristic that is of the retransmitted social information and that is associated with the social information retransmitting tree; a candidate key social information acquiring unit configured to input, into a preset filtering model, the characteristic vector that is of each piece of retransmitted social information and that is acquired by the characteristic vector acquiring unit, and acquire candidate key social information included in all retransmitted social information; a criticality evaluation value calculation unit configured to calculate a criticality evaluation value corresponding to each piece of candidate key social information acquired by the candidate key social information acquiring unit; and a key social information determining unit configured to select a preset amount of candidate key social information in descending order of criticality evaluation values from all candidate key social information according to the criticality evaluation value that is corresponding to each piece of candidate key social information and that is obtained by the criticality evaluation value calculation unit by means of calculation, and determine the selected candidate key social information as the key social information.

With reference to the second aspect, in a first possible implementation manner, the characteristic vector acquiring unit is configured to perform the following operations for any piece of retransmitted social information in the social information retransmitting tree: extracting a text characteristic of the any piece of retransmitted social information from content of the any piece of retransmitted social information, converting each characteristic amount included in the text characteristic of the any piece of retransmitted social information into a characteristic amount in a numerical value form by using a preset algorithm, and acquiring, according to all characteristic amounts in a numerical value form, a text characteristic vector corresponding to the any piece of retransmitted social information; acquiring, according to location information of a node represented by the any piece of retransmitted social information in the social information retransmitting tree and/or a quantity of nodes in the social information retransmitting tree that are brother nodes of the node represented by the any piece of retransmitted social information, a characteristic vector that is corresponding to the any piece of retransmitted social information and associated with the social information retransmitting tree; and combining the text characteristic vector and the characteristic vector associated with the social information retransmitting tree, to acquire a characteristic vector of the any piece of retransmitted social information, where the combination processing is performing up-and-down combination on the text characteristic vector and the characteristic vector associated with the social information retransmitting tree, or performing left-and-right combination on the text characteristic vector and the characteristic vector associated with the social information retransmitting tree.

With reference to the second aspect or the first possible implementation manner of the second aspect, in a second possible implementation manner, the apparatus further includes a filtering model generation unit configured to acquire training retransmitted social information of any piece of training original social information from historical data; generate a characteristic vector of each piece of training retransmitted social information according to an information characteristic of each piece of training retransmitted social information, where the characteristic vector of each piece of training retransmitted social information includes a vector that represents a text characteristic of the training retransmitted social information and a vector that represents a characteristic that is of the training retransmitted social information and that is associated with the social information retransmitting tree; acquire a filtering parameter by using a preset filtering algorithm according to the characteristic vector of each piece of training retransmitted social information and a known filtering and classification result of each piece of training retransmitted social information; and generate the filtering model according to the filtering parameter.

With reference to the first possible implementation manner or the second possible implementation manner of the second aspect, in a third possible implementation manner, that the filtering model generation unit acquires the filtering parameter by using the preset filtering algorithm according to the characteristic vector of each piece of training retransmitted social information and the known filtering and classification result of each piece of training retransmitted social information includes acquiring the filtering parameter by using a support vector machine algorithm according to the characteristic vector of each piece of training retransmitted social information and the known filtering and classification result of each piece of training retransmitted social information; or acquiring the filtering parameter by using a perceptron neural network algorithm according to the characteristic vector of each piece of training retransmitted social information and the known filtering and classification result of each piece of training retransmitted social information; or generating an input sequence according to the characteristic vector of each piece of training retransmitted social information and a retransmitting relationship between the pieces of training retransmitted social information, generating an output sequence according to the known filtering and classification result of each piece of training retransmitted social information, establishing a correlation function between the input sequence and the output sequence, determining a parameter of the correlation function according to the known filtering and classification result of each piece of training retransmitted social information, and determining the parameter as the filtering parameter.

With reference to the third possible implementation manner of the second aspect, in a fourth possible implementation manner, that the filtering model generation unit establishes the correlation function between the input sequence and the output sequence includes establishing a table of a link relationship between the input sequence and the output sequence according to a retransmitting relationship between characteristic vectors included in the input sequence and a relationship between each characteristic vector included in the input sequence and each filtering and classification result included in the output sequence; performing the following operations for any characteristic vector in the input sequence: scanning the table of the link relationship by using a window of a preset width, where a currently scanned window includes the any vector, generating a first partial correlation function according to a filtering and classification result in the output sequence and the any characteristic vector that are included in the currently scanned window, and generating a second partial correlation function according to the filtering and classification result in the output sequence that is included in the currently scanned window; and establishing the correlation function between the input sequence and the output sequence according to a first partial correlation function and a second partial correlation function that are corresponding to each vector included in the input sequence.

With reference to the second aspect or any one of the first possible implementation manner to the fourth possible implementation manner of the second aspect, in a fifth possible implementation manner, the criticality evaluation value calculation unit is configured to construct a candidate key social information diagram according to the candidate key social information, where the key social information diagram includes all the candidate key social information, and every two pieces of candidate key social information are connected to each other; and for any piece of candidate key social information in the candidate key social information diagram, acquire a value of a correlation between the any piece of candidate key social information and each of other pieces of candidate key social information, and determine, according to the value of the correlation between the any piece of candidate key social information and each of the other pieces of candidate key social information in the candidate key social information diagram, a criticality evaluation value corresponding to the any piece of candidate key social information.

With reference to the fifth possible implementation manner of the second aspect, in a sixth possible implementation manner, the criticality evaluation value obtained by the criticality evaluation value calculation unit by means of calculation meets the following formula:

$${R}_{t} ( v ) = λ {R}_{0} ( v ) + ( 1 - λ ) {\sum }_{i = 0}^{i = n} \frac{p ( {u}_{i} \to v ) {R}_{t - 1} ( v )}{{Z}_{t - 1} ( u )} ,$$

where Rₜ(v) is a criticality evaluation value obtained after the t^{th} iteration, λ is a preset coefficient, R₀(v) is a quantity of times candidate key social information v is retransmitted, n is a quantity of candidate key social information associated with the candidate key social information v in the candidate key social information diagram, Rₜ₋₁(v) is a criticality evaluation value obtained after the (t−1)^{th} iteration, p(uᵢ→v) is a value of a correlation between candidate key social information uᵢ, associated with the candidate key social information v and the candidate key social information v, and

$${Z}_{t - 1} ( u ) = {\sum }_{i = 0}^{i = n} p ( {u}_{i} \to v ) {R}_{t - 1} ( v ) .$$

In the embodiments of the present disclosure, directly-retransmitted social information and indirectly-retransmitted social information of original social information are acquired, and a social information retransmitting tree is established; an information characteristic of each piece of retransmitted social information in the social information retransmitting tree is acquired; a characteristic vector of each piece of retransmitted social information is determined according to the information characteristic of the retransmitted social information; the obtained characteristic vector is input into a preset filtering model, and candidate key social information is acquired; and final key social information is selected from all candidate key social information according to a criticality evaluation value of each piece of candidate key social information. In the technical solution of the present disclosure, directly-retransmitted social information and indirectly-retransmitted social information are comprehensively considered, and key social information is selected from all retransmitted social information of original social information, which avoids a problem of a one-sided selection result that is caused when key social information is selected only from directly-retransmitted social information, and improves accuracy of a selection result. In addition, in a process of selecting the key social information, content of retransmitted social information and a characteristic associated with a social information retransmitting tree are used as reference factors for selecting the key social information, which further improves the accuracy of the final selection result.

### BRIEF DESCRIPTION OF THE DRAWINGS

FIG. 1 is a flowchart of determining key social information according to an embodiment of the present disclosure;

FIG. 2 is a schematic diagram of a social information retransmitting tree according to an embodiment of the present disclosure;

FIG. 3 is a flowchart of generating a filtering model according to an embodiment of the present disclosure;

FIG. 4A is a schematic diagram of a table of a link relationship according to an embodiment of the present disclosure;

FIG. 4B is a table of a preset characteristic value relationship of a second partial correlation function according to an embodiment of the present disclosure;

FIG. 5 is a candidate key social information diagram according to an embodiment of the present disclosure;

FIG. 6 is a schematic structural diagram of an apparatus for determining key social information according to an embodiment of the present disclosure; and

FIG. 7 is a schematic structural diagram of a device for determining key social information according to an embodiment of the present disclosure.

### DETAILED DESCRIPTION

To resolve a problem of low selection result accuracy currently existing in a process of selecting key retransmitted social information from retransmitted social information, in embodiments of the present disclosure, directly-retransmitted social information and indirectly-retransmitted social information of original social information are acquired, and a social information retransmitting tree is established; an information characteristic of each piece of retransmitted social information in the social information retransmitting tree is acquired; a characteristic vector of each piece of retransmitted social information is determined according to the information characteristic of the retransmitted social information; the obtained characteristic vector is input into a preset filtering model, and candidate key social information is acquired; and final key social information is selected from all candidate key social information according to a criticality evaluation value of each piece of candidate key social information. In the technical solution of the present disclosure, directly-retransmitted social information and indirectly-retransmitted social information are comprehensively considered, and key social information is selected from all retransmitted social information of original social information, which avoids a problem of a one-sided selection result that is caused when key social information is selected only from directly-retransmitted social information, and improves accuracy of a selection result. In addition, in a process of selecting the key social information, content of retransmitted social information and a characteristic associated with a social information retransmitting tree are used as reference factors for selecting the key social information, which further improves the accuracy of the final selection result.

In the embodiments of the present disclosure, any terminal that has a data processing capability may execute an operation of determining key social information. For example, the terminal is a server, or the terminal is a computer.

The following further describes the embodiments of the present disclosure in detail with reference to accompanying drawings in this specification.

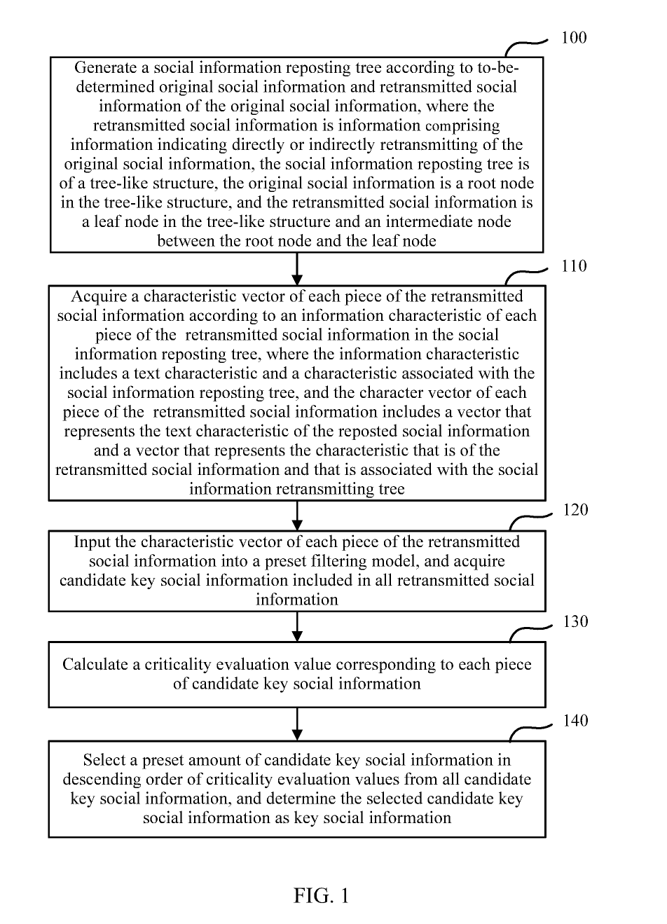

Referring to FIG. 1, in an embodiment of the present disclosure, a method for determining key social information includes the following steps.

Step 100: Generate a social information retransmitting tree according to to-be-determined original social information and retransmitted social information of the original social information, where the retransmitted social information comprising information indicating directly or indirectly retransmission of the original social information, the social information retransmitting tree is of a tree-like structure, the original social information is a root node in the tree-like structure, and the retransmitted social information is a leaf node in the tree-like structure and an intermediate node between the root node and the leaf node.

In this embodiment of the present disclosure, a terminal acquires the to-be-determined original social information and the retransmitted social information obtained after directly or indirectly retransmitting the original social information, and generates the social information retransmitting tree according to the original social information and a retransmitting relationship between all retransmitted social information.

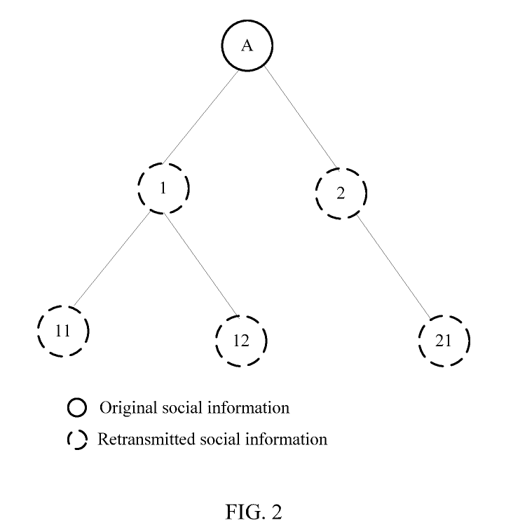

On the generated social information retransmitting tree, the original social information is used as a root node, and all the retransmitted social information are used as leaf nodes and intermediate nodes. When there is any piece of retransmitted social information that is not retransmitted by any social user, the any piece of retransmitted social information is used as a leaf node in the social information retransmitting tree, and when there is any piece of retransmitted social information that is retransmitted by a social user, the any piece of retransmitted social information is used as an intermediate node in the social information retransmitting tree. In addition, a location that is of a node represented by each piece of retransmitted social information and that is in the social information retransmitting tree is determined according to the retransmitting relationship between all the retransmitted social information. For example, referring to FIG. 2, FIG. 2 is a schematic diagram of a social information retransmitting tree. Retransmitted social information of original social information A is retransmitted social information 1 retransmitted social information 11 retransmitted social information 12, retransmitted social information 2 and retransmitted social information 21 where the retransmitted social information 1 and the retransmitted social information 2 are directly-retransmitted social information, and the retransmitted social information 11 the retransmitted social information 12, and the retransmitted social information 21 are indirectly-retransmitted social information. It may be learned, according to the social information retransmitting tree, that the retransmitted social information 1 is retransmitted twice, that is, the retransmitted social information 11 and the retransmitted social information 12 obtained after the retransmitted social information 1 is retransmitted, and the retransmitted social information 2 is retransmitted once, that is, the retransmitted social information 21 obtained after the retransmitted social information 2 is retransmitted. Optionally, a quantity of comments on each piece of retransmitted social information may further be recorded on the foregoing social information retransmitting tree.

It may be learned that a location, a brother node, and a subnode of each piece of retransmitted social information in a process of retransmitting the information, a quantity of times for which each piece of retransmitted social information is retransmitted, and a quantity of comments on each piece of retransmitted social information can be more intuitively determined according to the social information retransmitting tree.

By using the foregoing technical solution, the terminal generates the social information retransmitting tree according to the retransmitted social information of the original social information, and the terminal can more conveniently and quickly determine, according to the social information retransmitting tree, a characteristic that is of each piece of retransmitted social information and associated with the social information retransmitting tree, so that key social information can be determined more quickly, and a data processing speed is improved.

Step 110: Acquire a characteristic vector of each piece of retransmitted social information according to an information characteristic of each piece of retransmitted social information in the social information retransmitting tree, where the information characteristic includes a text characteristic and a characteristic associated with the social information retransmitting tree, and the character vector of each piece of retransmitted social information includes a vector that represents the text characteristic of the retransmitted social information and a vector that represents the characteristic that is of the retransmitted social information and that is associated with the social information retransmitting tree.

In this embodiment of the present disclosure, the terminal acquires the information characteristic of each piece of retransmitted social information included in the social information retransmitting tree, where the information characteristic includes the text characteristic and the characteristic associated with the social information retransmitting tree, the text characteristic is determined according to content of the retransmitted social information, and the characteristic associated with the social information retransmitting tree is determined according to a location that is of the retransmitted social information and that is in the social information retransmitting tree. The terminal generates the characteristic vector of the retransmitted social information according to the acquired information characteristic of each piece of retransmitted social information.

A process in which the terminal generates the characteristic vector of each piece of retransmitted social information includes performing the following operations for any piece of retransmitted social information in the social information retransmitting tree: extracting a text characteristic of the any piece of retransmitted social information according to content of the any piece of retransmitted social information, where the text characteristic may be a word, a bigram, a part of speech, an emoticon, an address link, or the like included in the any piece of retransmitted social information; acquiring, according to information about a location of the any piece of retransmitted social information in the social information retransmitting tree and/or a quantity of nodes in the social information retransmitting tree that are brother nodes of a node represented by the any piece of retransmitted social information, the characteristic associated with the social information retransmitting tree, where the characteristic associated with the social information retransmitting tree may be a quantity of times the any piece of retransmitted social information is retransmitted, a quantity of comments on the any piece of retransmitted social information, or the like; performing an operation on the text characteristic by using a preset algorithm, and acquiring a text characteristic vector corresponding to the any piece of retransmitted social information; acquiring a characteristic vector that is corresponding to the any piece of retransmitted social information and associated with the social information retransmitting tree; and combining the text characteristic vector and the characteristic vector associated with the social information retransmitting tree, to acquire a characteristic vector of the any piece of retransmitted social information.

Optionally, in the foregoing process, when the text characteristic is a word, a bigram, or a part of speech included in the any piece of retransmitted social information, the terminal may first perform word segmentation on text content included in the any piece of retransmitted social information, and determine, according to a result of the word segmentation, a word included in the any piece of retransmitted social information and a part of speech of each word, a bigram corresponding to the any piece of retransmitted social information, and the like. When the text characteristic is an emoticon, an address link, or the like, the terminal may perform word segmentation on text content included in the any piece of retransmitted social information; perform matching between a segmented word separately with a preset emoticon set and a keyword of an address link, and when the segmented word is the same as any emoticon in the emoticon set, determine that the segmented word is an emoticon; and extract a keyword in the segmented word, and when the extracted keyword successfully matches the keyword of the address link, determine that the segmented word is an address link.

Optionally, performing the operation on the text characteristic by using the preset algorithm, and generating the text characteristic vector corresponding to the any piece of retransmitted social information includes performing an operation on the text characteristic based on a maximum-entropy Markov model or by using a method such as a conditional random field (CRF), and generating the text characteristic vector corresponding to the any piece of retransmitted social information. The generated text characteristic vector is a multi-dimensional vector, and a meaning represented by each dimension is related to an algorithm for calculating a text characteristic vector. For example, retransmitted social information is “a company launches a new handset”, and word segmentation is performed on the retransmitted social information, where segmented words are “company”, “launch”, “new”, and “handset”; an index dictionary is introduced, where the index dictionary includes an index number of each word, a quantity of words included in the index dictionary is a dimension of the index dictionary, that is, a dimension of a generated text characteristic vector, and if the index dictionary includes 100 words, the dimension of the index dictionary is 100, and the dimension of the generated text characteristic vector is 100; the index dictionary is searched for index numbers of the foregoing segmented words. If an index number of the word “company” is 1 an element value on the first dimension of the text characteristic vector is set to 1; if an index number of the word “launch” is 20, an element value on the 20^{th} dimension of the text characteristic vector is set to 1; if an index number of the word “new” is 34, an element value on the 34^{th} dimension of the text characteristic vector is set to 1; if an index number of the word “handset” is 54, an element value on the 54^{th} dimension of the text characteristic vector is set to 1; element values on other dimensions except the first dimension, the 20^{th} dimension, the 34^{th} dimension, and the 54^{th} dimension in all dimensions of the characteristic vector are set to 0.

Because a text characteristic is generally in a text form, by using the foregoing technical solution, the text characteristic is quantized, that is, the text characteristic is converted into a numerical value form, and the text characteristic in a numerical value form is determined as a text characteristic vector, which facilitates subsequent selection of key social information.

Optionally, generating the characteristic vector that is corresponding to the any piece of retransmitted social information and associated with the social information retransmitting tree includes acquiring, according to location information of a node represented by the any piece of retransmitted social information in the social information retransmitting tree and/or a quantity of nodes in the social information retransmitting tree that are brother nodes of the node represented by the any piece of retransmitted social information, the characteristic vector that is corresponding to the any piece of retransmitted social information and associated with the social information retransmitting tree. The generated characteristic vector associated with the social information retransmitting tree is a multi-dimensional vector, and a meaning represented by each dimension is related to a setting status. For example, for retransmitted social information T, a node t represented by the retransmitted social information T in a social information retransmitting tree includes four brother nodes, a distance between the node t and a root node is 6, a quantity of subnodes of the node t is 2 and a quantity of comments on the retransmitted social information T is 378. When a characteristic vector associated with the social information retransmitting tree is set as the following: a first dimension represents a distance from the root node, a second dimension represents a quantity of subnodes, a third dimension represents a quantity of comments, and a fourth dimension represents a quantity of brother nodes, the generated characteristic vector associated with the social information retransmitting tree is a four-dimensional vector, and may be represented as {6, 2, 387, 6}.

Optionally, generating the characteristic vector of the any piece of retransmitted social information according to the text characteristic vector of the any piece of retransmitted social information and the characteristic vector associated with the social information retransmitting tree includes combining the acquired text characteristic vector and the characteristic vector associated with the social information retransmitting tree, to generate the characteristic vector of the any piece of retransmitted social information, where the foregoing combination processing manner may be preset according to a specific case. For example, the combination processing is performing up-and-down combination on the text characteristic vector and the characteristic vector associated with the social information retransmitting tree, or performing left-and-right combination on the text characteristic vector and the characteristic vector associated with the social information retransmitting tree. For example, if the text characteristic vector of the any piece of retransmitted social information is a={a1, a2}, and the characteristic vector that is of the any piece of retransmitted social information and associated with the social information retransmitting tree is b={b1, b2}, the characteristic vector of the any piece of retransmitted social information is c={a1, a2, b1, b2}.

By using the foregoing technical solution, the text characteristic vector is generated according to the content of the retransmitted social information; the characteristic vector that is corresponding to the any piece of retransmitted social information and associated with the social information retransmitting tree is generated according to the location that is of the retransmitted social information and that is in the social information retransmitting tree and/or the quantity of nodes in the social information retransmitting tree that are brother nodes of the node represented by the any piece of retransmitted social information. In a process of generating the characteristic vector, the content of the retransmitted social information and the location that is of the retransmitted social information and that is in the social information retransmitting tree are comprehensively considered, so that in a process of determining key retransmitted social information, both impact of content of retransmitted social information on a selection result and impact of influence of retransmitted social information on the selection result are considered, and accuracy of a selection result is ensured.

Step 120: Input the characteristic vector of each piece of retransmitted social information into a preset filtering model, and acquire candidate key social information included in all retransmitted social information.

In this embodiment of the present disclosure, the terminal inputs the acquired characteristic vector of each piece of retransmitted social information into the preset filtering model, and acquires candidate social information output by the filtering model. Based on the foregoing process, all candidate social information output by the filtering model is retransmitted social information that is representative in content and that has the largest quantity of retransmitting and the largest quantity of comments.

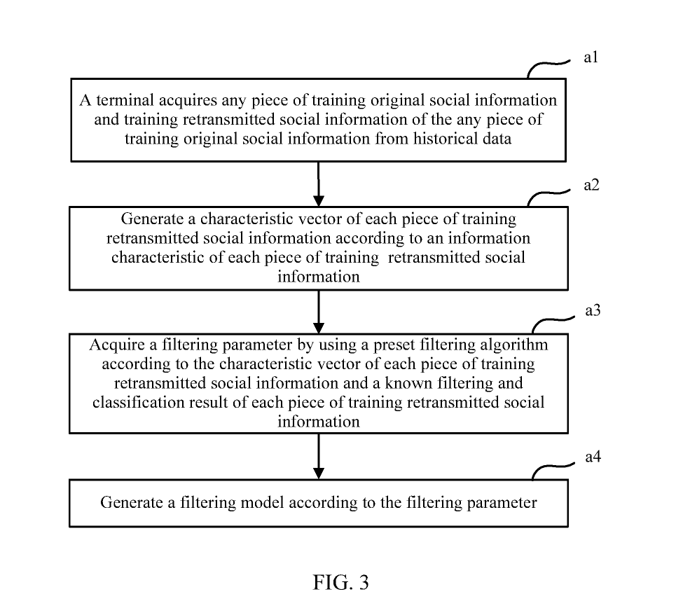

Optionally, referring to FIG. 3, a method for generating the filtering model includes the following steps.

Step a1: A terminal acquires any piece of training original social information and training retransmitted social information of the any piece of training original social information from historical data.

In this embodiment of the present disclosure, a filtering and classification result corresponding to the foregoing training retransmitted social information is known, that is, whether each piece of training retransmitted social information is candidate key social information is known. The terminal may mark the training retransmitted social information (denoted as yᵢ, where i is an identity of retransmitted social information, and for example, i is a serial number) in a text form. For example, yᵢ=candidate key social information. Alternatively, the terminal may mark the training retransmitted social information in a binary form. For example, yᵢ=1 indicates that the training retransmitted social information is candidate key social information, and yᵢ=0 indicates that the training retransmitted social information is not candidate key social information.

Step a2: Generate a characteristic vector of each piece of training retransmitted social information according to an information characteristic of each piece of training retransmitted social information.

In this embodiment of the present disclosure, the characteristic vector of each piece of training retransmitted social information is denoted as x, where i is an identity of retransmitted social information. For example, i is a serial number.

Further, after acquiring the any piece of training original social information and the training retransmitted social information of the any piece of training original social information, the terminal generates a training social information retransmitting tree according to the any piece of training original social information and the training retransmitted social information of the training original social information; the terminal generates the information characteristic of each piece of training retransmitted social information according to the training social information retransmitting tree and text content of each piece of training retransmitted social information; the terminal generates the characteristic vector of each piece of training retransmitted social information according to the information characteristic of each piece of training retransmitted social information.

In the foregoing step, for any piece of training retransmitted social information, the terminal performs extraction on text content of the any piece of training retransmitted social information according to a preset rule, to acquire corresponding information such as a word, a bigram, a part of speech, an address link, and an emoticon, and performs an operation on the acquired information by using a preset algorithm to obtain a text characteristic vector of the any piece of training retransmitted social information.

Further, for the any piece of training retransmitted social information, the terminal acquires, according to location information of a node represented by the any piece of training retransmitted social information and/or a quantity of nodes in the training social information retransmitting tree that are brother nodes of the node represented by the any piece of training retransmitted social information, a characteristic vector that is corresponding to the any piece of training retransmitted social information and associated with the training social information retransmitting tree.

Further, for the any piece of training retransmitted social information, the terminal performs combination processing on the foregoing obtained text characteristic vector and characteristic vector associated with the training social information retransmitting tree, and generates a characteristic vector of the any piece of training retransmitted social information.

Step a3: Acquire a filtering parameter by using a preset filtering algorithm according to the characteristic vector of each piece of training retransmitted social information and a known filtering and classification result of each piece of training retransmitted social information.

In this embodiment of the present disclosure, the terminal may acquire the filtering parameter in the following three manners.

In the first manner, the filtering parameter is acquired by using a support vector machine algorithm according to the characteristic vector of each piece of training retransmitted social information and the known filtering and classification result of each piece of training retransmitted social information.

In the second manner, the filtering parameter is acquired by using a perceptron neural network algorithm according to the characteristic vector of each piece of training retransmitted social information and the known filtering and classification result of each piece of training retransmitted social information.

In the foregoing first manner and second manner, the filtering parameter is acquired directly according to the known filtering and classification result, and a retransmitting relationship between characteristic vectors of different training retransmitted social information is not considered. Therefore, the filtering parameter is obtained by means of calculation at a higher speed.

In the third manner, an input sequence is generated according to the characteristic vector of each piece of training retransmitted social information and a retransmitting relationship between the pieces of training retransmitted social information, where the input sequence may be represented as x₁, x₂, . . . , xₙ, and the n characteristic vectors belong to a same retransmitting link in the training social information retransmitting tree; an output sequence is generated according to the known filtering and classification result of each piece of training retransmitted social information, where a ranking of each filtering and classification result in the generated output sequence is determined by each characteristic vector in the input sequence, and for example, if a location number of any characteristic vector in the input sequence is i, a location number of a filtering and classification result, corresponding to the any characteristic vector, in the output sequence is also i; a correlation function between the input sequence and the output sequence is established, where the correlation function is a function used to represent an association between a characteristic vector and a filtering and classification result; a parameter of the correlation function is determined according to the known filtering and classification result of each piece of training retransmitted social information; and the parameter is determined as the filtering parameter.

Optionally, a process in which the terminal establishes the correlation function between the input sequence and the output sequence includes establishing a table of a link relationship between the input sequence and the output sequence according to a retransmitting relationship between characteristic vectors included in the input sequence and a relationship between each characteristic vector included in the input sequence and each filtering and classification result included in the output sequence, where the table of the link relationship includes two rows, the first row represents the input sequence, and the second row represents the output sequence; and performing the following operations for any characteristic vector in the input sequence: scanning the table of the link relationship by using a window of a preset width (denoted as k), where a currently scanned window includes only the any vector and multiple filtering and classification results; generating a first partial correlation function according to a filtering and classification result in the output sequence and the any characteristic vector that are included in the currently scanned window, where the first partial correlation function is a function used to represent an association between the any characteristic vector and the filtering and classification result included in the currently scanned window; generating a second partial correlation function according to the filtering and classification result in the output sequence that is included in the currently scanned window, where the second partial correlation function is a function used to represent an association between a filtering and classification result corresponding to the any vector and another filtering and classification result included in the currently scanned window; and establishing the correlation function between the input sequence and the output sequence according to a first partial correlation function and a second partial correlation function that are corresponding to each vector included in the input sequence. The preset width k of the foregoing window may be preset according to a specific application scenario. Optionally, a value range of k is from 3 to 5 (including 3 and 5).

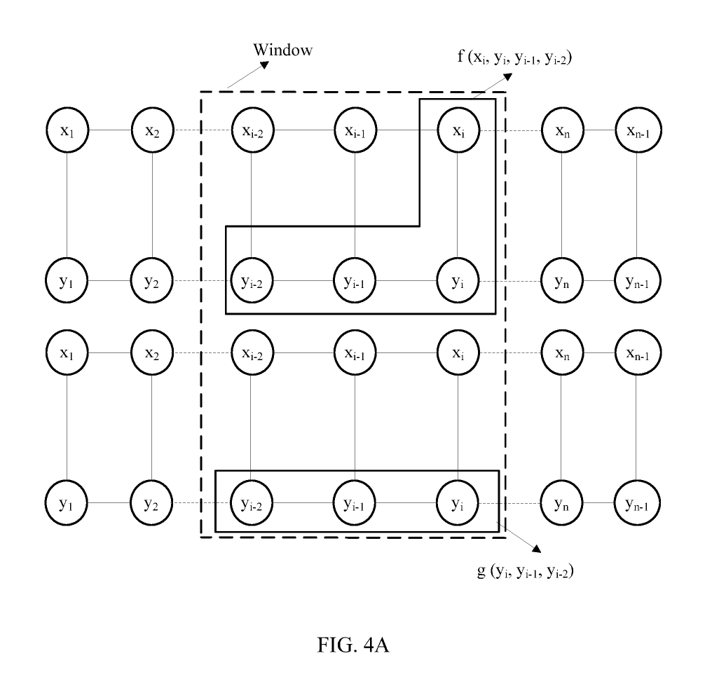

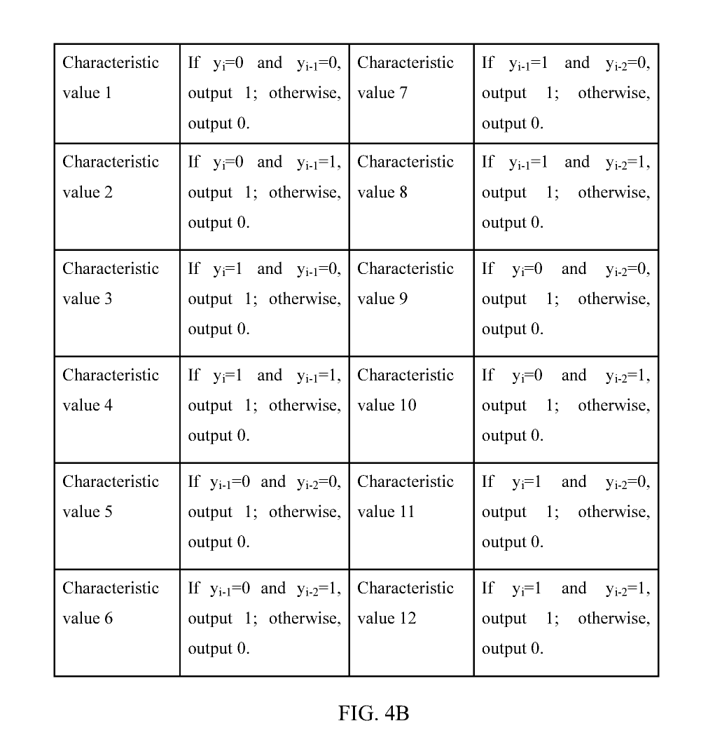

For example, referring to FIG. 4A, FIG. 4A shows a table of a link relationship and a window of a preset width in this embodiment of the present disclosure, where an input sequence is {x₁, x₂, . . . , xₙ}, an output sequence is {y₁, y₂, . . . , yₙ}, and a quantity of characteristic vectors included in the input sequence is necessarily equal to a quantity of filtering and classification results included in the output sequence. In FIG. 4A, xᵢ is any characteristic vector, a first partial correlation function of the any characteristic vector xᵢ is denoted as f(xᵢ, yᵢ₋₁, yᵢ₋₂), and a second partial correlation function of the any characteristic vector xᵢ is denoted as g(yᵢ, yᵢ₋₁, yᵢ₋₂).

Optionally, when the preset width k of the window is 3, the first partial correlation function of the any characteristic vector xᵢ meets the following formula:

f(xᵢ, yᵢ, yᵢ₋₁, yᵢ₋₂)=ᵢω_{y}_{ᵢ}_{, y}_{_{i−1}}_{, y}_{_{i−2}}, where xᵢ is any characteristic vector, ω_{y}_{ᵢ}_{, y}_{_{i−1}}_{, y}_{_{i−2}} is a parameter of a first partial correlation function and is a high-dimensional vector, a dimension of ω_{y}_{ᵢ}_{, y}_{_{i−1}}_{, y}_{_{i−2}} is the same as a dimension of the any characteristic vector x_{I}, and yᵢ, and yᵢ₋₂, represent indexes of ω_{y}_{ᵢ}_{, y}_{_{i−1}}_{, y}_{_{i−2}}.

In this embodiment of the present disclosure, because and yᵢ, yᵢ₋₁, yᵢ₋₂ represent indexes of ω_{y}_{ᵢ}_{, y}_{_{i−1}}_{, y}_{_{i−2}}, when yᵢ=0, yᵢ₋₁=1, and yᵢ₋₂=1, a value of ω_{y}_{ᵢ}_{, y}_{_{i−1}}_{, y}_{_{i−2}} is ω_{0,1,1,}. It may be learned, on this basis, that when k=3, a value of the parameter of the first partial correlation function includes eight cases.

Optionally, the second partial correlation function of the any characteristic vector xᵢ meets the following formula:

g(yᵢ, yᵢ₋₁, yᵢ₋₂)=φ(yᵢ, yᵢ₋₁, yᵢ₋₂)×ωₜᵣ, where φ(uᵢ, yᵢ₋₁, yᵢ₋₂) represents a preset characteristic value obtained according to values of yᵢ, yᵢ₋₁, and yᵢ₋₂, a correspondence between the values of yᵢ, yᵢ₋₁, and yᵢ₋₂ and the preset characteristic value is shown in FIG. 4B, ωₜᵣ is a parameter of a second partial correlation function and is a high-dimensional vector, and a dimension of ωₜᵣ is the same as a dimension of φ(yᵢ, y₁₋₁, yᵢ₋₂).

Optionally, the correlation function f(x₁, x₂, . . . , xₙ, y₁, y₂, . . . , yₙ), generated based on the foregoing first partial correlation function f(xᵢ, yᵢ₋₁, yᵢ₋₂) and the foregoing second partial correlation function g(yᵢ, yᵢ₋₁, yᵢ₋₂), between the input sequence and the output sequence meets the following formula:

$$f ( {x}_{1} , {x}_{2} , … , {x}_{n} , {y}_{1} , {y}_{2} , … , {y}_{n} ) = {\sum }_{i = 1}^{n} [ {x}_{i} \times {ω}_{{y}_{i} , {y}_{i - 1} , {y}_{i - 2}} + φ ( {y}_{i} , {y}_{i - 1} , {y}_{i - 2} ) \times {ω}_{tr} ] ,$$

where xᵢ is any characteristic vector, ω_{y}_{ᵢ}_{, y}_{_{i−1}}_{, y}_{_{i−2}} is a parameter of a first partial correlation function, φ(Yᵢ, yᵢ₋₁, yᵢ₋₂) represents a preset characteristic value obtained according to values of and yᵢ₋₂, and ωₜᵣ is a parameter of a second partial correlation function.

In the third manner, the terminal comprehensively considers a retransmitting relationship between different training retransmitted social information in the training social information retransmitting tree to obtain a parameter of a filtering model, which ensures that the obtained filtering model further improves accuracy of a final selection result by using the retransmitting relationship between different retransmitted social information.

Step a4: Generate a filtering model according to the filtering parameter.

In this embodiment of the present disclosure, the terminal generates the filtering model according to the filtering parameter and the correlation function between the input sequence and the output sequence.

By using the foregoing technical solution, in a process of establishing the filtering model, in addition to considering a characteristic of directly-retransmitted social information, the terminal further introduces indirectly-retransmitted social information, which ensures comprehensiveness of an output result of the finally generated filtering model. In addition, the terminal not only uses text content of retransmitted social information as a reference factor, but also comprehensively considers reference factors, such as a retransmitting relationship between retransmitted social information, retransmitting times of retransmitted social information, and comments on retransmitted social information, which further improves accuracy of the output result of the filtering model.

Based on the foregoing generated filtering model, the terminal may acquire, according to the characteristic vector of each piece of retransmitted social information, a result output by the filtering model; the terminal uses the result output by the filtering model as candidate key social information.

Step 130: Calculate a criticality evaluation value corresponding to each piece of candidate key social information.

In this embodiment of the present disclosure, the terminal constructs a candidate key social information diagram according to the candidate key social information; and for any piece of candidate key social information in the candidate key social information diagram, determines, according to values of correlations between the any piece of candidate key social information in the candidate key social information diagram and all other pieces of candidate key social information, a criticality evaluation value corresponding to the any piece of candidate key social information.

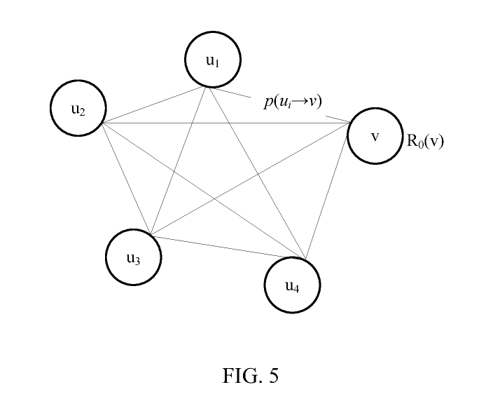

For example, referring to FIG. 5, FIG. 5 is a candidate key social information diagram according to an embodiment of the present disclosure. The candidate key social information diagram includes all candidate key social information (u₁, u₂, u₃, u₄, v), and each piece of candidate key social information is connected to all pieces of the remaining candidate key social information. In addition, each piece of candidate key social information included in the candidate information diagram is corresponding to a value R₀(v), and R₀(v) is a quantity of times any piece of candidate key social information v is retransmitted. A connection line between every two pieces of candidate key social information (such as uᵢ and v) is used to indicate that there is a correlation (a value of the correlation is denoted as p(uᵢ→v)) between the two pieces of candidate key social information.

Optionally, for any piece of candidate key social information in the candidate key social information diagram, a value of a correlation between the any piece of candidate key social information and each of other pieces of candidate key social information is acquired, and a criticality evaluation value corresponding to the any piece of candidate key social information is determined according to the value of the correlation between the any piece of candidate key social information and each of the other pieces of candidate key social information in the candidate key social information diagram. The criticality evaluation value meets the following formula:

$${R}_{t} ( v ) = λ {R}_{0} ( v ) + ( 1 - λ ) {\sum }_{i = 0}^{i = n} \frac{p ( {u}_{i} \to v ) {R}_{t - 1} ( v )}{{Z}_{t - 1} ( u )} ,$$

where Rₜ(v) is a criticality evaluation value obtained after the t^{th} iteration, λ is a preset coefficient, R₀(v) is a quantity of times candidate key social information v is retransmitted, n is a quantity of candidate key social information associated with the candidate key social information v in the candidate key social information diagram, Rᵢ₋₁(v) is a criticality evaluation value obtained after the (t−1)^{th} iteration, p(uᵢ→v) is a value of a correlation between candidate key social information uᵢ associated with the candidate key social information v and the candidate key social information v, the value of the correlation is initialized to a dot product of a characteristic vector of the candidate key social information uᵢ and a characteristic vector of the candidate key social information v, and

$${Z}_{t - 1} ( u ) = {\sum }_{i = 0}^{i = n} p ( {u}_{i} \to v ) {R}_{t - 1} ( v ) .$$

Step 140: Select a preset amount of candidate key social information in descending order of criticality evaluation values from all candidate key social information, and determine the selected candidate key social information as key social information.

In this embodiment of the present disclosure, the terminal selects, from all the candidate key social information acquired in the foregoing iteration process, candidate key social information that is of the preset quantity and that has the largest criticality evaluation value, and uses the selected candidate key social information as the key social information, where the preset quantity may be preset according to a specific application scenario.

Further, when multiple related social information retransmitting trees need to be combined, and key social information in all combined retransmitted social information needs to be acquired, the terminal may acquire candidate key social information corresponding to each social information retransmitting tree by using step 100 to step 120; generates, by using step 130, a candidate key social information diagram according to candidate key social information corresponding to all social information retransmitting trees, and calculates a criticality evaluation value of each piece of candidate key social information; and the terminal selects, from all the candidate key social information by using step 140 candidate key social information that is of a preset quantity and that has the largest criticality evaluation value, and determines the selected candidate key social information as key social information. In the prior art, in a process of calculating only key social information corresponding to each social information retransmitting tree for multiple related social information retransmitting trees, there is no association between the obtained key social information. By contrast, in the technical solution of the present disclosure, key social information corresponding to all social information retransmitting trees can be obtained with reference to an association between all the social information retransmitting trees, and the acquired social information is more reliable.

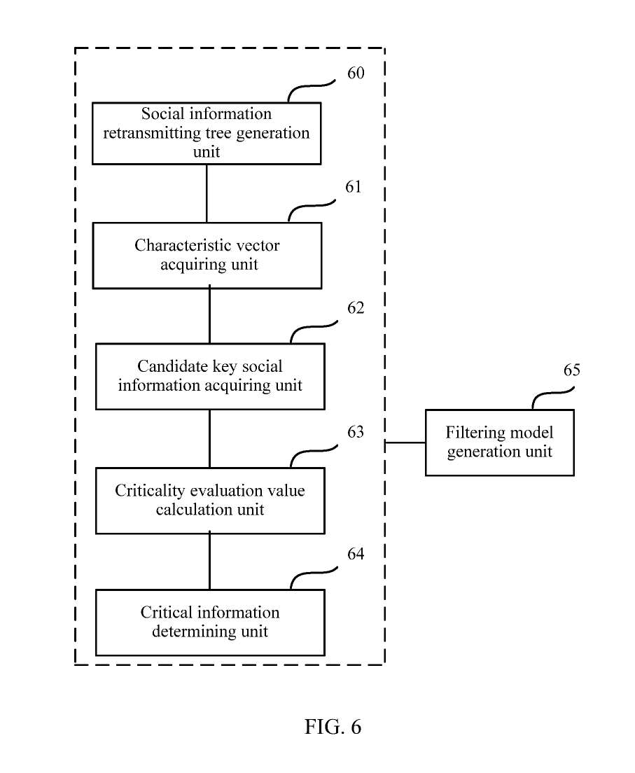

Based on the foregoing technical solution, referring to FIG. 6, an embodiment of the present disclosure provides an apparatus for determining key social information, including a social information retransmitting tree generation unit 60, a characteristic vector acquiring unit 61, a candidate key social information acquiring unit 62, a criticality evaluation value calculation unit 63, and a key social information determining unit 64.

The social information retransmitting tree generation unit 60 is configured to generate a social information retransmitting tree according to to-be-determined original social information and retransmitted social information of the original social information, where the retransmitted social information comprising information indicating directly or indirectly retransmission of the original social information, the social information retransmitting tree is of a tree-like structure, the original social information is a root node in the tree-like structure, and the retransmitted social information is a leaf node in the tree-like structure and an intermediate node between the root node and the leaf node.

The characteristic vector acquiring unit 61 is configured to acquire a characteristic vector of each piece of retransmitted social information according to an information characteristic of each piece of retransmitted social information, where the information characteristic includes a text characteristic and a characteristic associated with the social information retransmitting tree, and the character vector of each piece of retransmitted social information includes a vector that represents the text characteristic of the retransmitted social information and a vector that represents the characteristic that is of the retransmitted social information and that is associated with the social information retransmitting tree.

The candidate key social information acquiring unit 62 is configured to input, into a preset filtering model, the characteristic vector that is of each piece of retransmitted social information and that is acquired by the characteristic vector acquiring unit 61, and acquire candidate key social information included in all retransmitted social information.

The criticality evaluation value calculation unit 63 is configured to calculate a criticality evaluation value corresponding to each piece of candidate key social information acquired by the candidate key social information acquiring unit 62.

The key social information determining unit 64 is configured to select a preset amount of candidate key social information in descending order of criticality evaluation values from all candidate key social information according to the criticality evaluation value that is corresponding to each piece of candidate key social information and that is obtained by the criticality evaluation value calculation unit 63 by means of calculation, and determine the selected candidate key social information as the key social information.

Optionally, the characteristic vector acquiring unit 61 is configured to perform the following operations for any piece of retransmitted social information in the social information retransmitting tree: extracting a text characteristic of the any piece of retransmitted social information from content of the any piece of retransmitted social information, converting each characteristic amount included in the text characteristic of the any piece of retransmitted social information into a characteristic amount in a numerical value form by using a preset algorithm, and acquiring, according to all characteristic amounts in a numerical value form, a text characteristic vector corresponding to the any piece of retransmitted social information; acquiring, according to location information of a node represented by the any piece of retransmitted social information in the social information retransmitting tree and/or a quantity of nodes in the social information retransmitting tree that are brother nodes of the node represented by the any piece of retransmitted social information, a characteristic vector that is corresponding to the any piece of retransmitted social information and associated with the social information retransmitting tree; and combining the text characteristic vector and the characteristic vector associated with the social information retransmitting tree, to acquire a characteristic vector of the any piece of retransmitted social information, where the combination processing is performing up-and-down combination on the text characteristic vector and the characteristic vector associated with the social information retransmitting tree, or performing left-and-right combination on the text characteristic vector and the characteristic vector associated with the social information retransmitting tree.

Further, the apparatus includes a filtering model generation unit 65 configured to acquire training retransmitted social information of any piece of training original social information from historical data; generate a characteristic vector of each piece of training retransmitted social information according to an information characteristic of each piece of training retransmitted social information, where the characteristic vector of each piece of training retransmitted social information includes a vector that represents a text characteristic of the training retransmitted social information and a vector that represents a characteristic that is of the training retransmitted social information and that is associated with the social information retransmitting tree; acquire a filtering parameter by using a preset filtering algorithm according to the characteristic vector of each piece of training retransmitted social information and a known filtering and classification result of each piece of training retransmitted social information; and generate the filtering model according to the filtering parameter.

Optionally, that the filtering model generation unit 65 acquires the filtering parameter by using the preset filtering algorithm according to the characteristic vector of each piece of training retransmitted social information and the known filtering and classification result of each piece of training retransmitted social information includes acquiring the filtering parameter by using a support vector machine algorithm according to the characteristic vector of each piece of training retransmitted social information and the known filtering and classification result of each piece of training retransmitted social information; or acquiring the filtering parameter by using a perceptron neural network algorithm according to the characteristic vector of each piece of training retransmitted social information and the known filtering and classification result of each piece of training retransmitted social information; or generating an input sequence according to the characteristic vector of each piece of training retransmitted social information and a retransmitting relationship between the pieces of training retransmitted social information, generating an output sequence according to the known filtering and classification result of each piece of training retransmitted social information, establishing a correlation function between the input sequence and the output sequence, determining a parameter of the correlation function according to the known filtering and classification result of each piece of training retransmitted social information, and determining the parameter as the filtering parameter.

Optionally, that the filtering model generation unit 65 establishes the correlation function between the input sequence and the output sequence includes establishing a table of a link relationship between the input sequence and the output sequence according to a retransmitting relationship between characteristic vectors included in the input sequence and a relationship between each characteristic vector included in the input sequence and each filtering and classification result included in the output sequence; and performing the following operations for any characteristic vector in the input sequence: scanning the table of the link relationship by using a window of a preset width, where a currently scanned window includes the any vector, generating a first partial correlation function according to a filtering and classification result in the output sequence and the any characteristic vector that are included in the currently scanned window, and generating a second partial correlation function according to the filtering and classification result in the output sequence that is included in the currently scanned window; and establishing the correlation function between the input sequence and the output sequence according to a first partial correlation function and a second partial correlation function that are corresponding to each vector included in the input sequence.

Optionally, the criticality evaluation value calculation unit 63 is configured to construct a candidate key social information diagram according to the candidate key social information, where the key social information diagram includes all the candidate key social information, and every two pieces of candidate key social information are connected to each other; and for any piece of candidate key social information in the candidate key social information diagram, acquire a value of a correlation between the any piece of candidate key social information and each of other pieces of candidate key social information, and determine, according to the value of the correlation between the any piece of candidate key social information and each of the other pieces of candidate key social information in the candidate key social information diagram, a criticality evaluation value corresponding to the any piece of candidate key social information.

Optionally, the criticality evaluation value obtained by the criticality evaluation value calculation unit 63 by means of calculation meets the following formula:

$${R}_{t} ( v ) = λ {R}_{0} ( v ) + ( 1 - λ ) {\sum }_{i = 0}^{i = n} \frac{p ( {u}_{i} \to v ) {R}_{t - 1} ( v )}{{Z}_{t - 1} ( u )} ,$$

where Rₜ(v) is a criticality evaluation value obtained after the t^{th} iteration, λ is a preset coefficient, R₀(v) is a quantity of times candidate key social information v is retransmitted, n is a quantity of candidate key social information associated with the candidate key social information v in the candidate key social information diagram, Rᵢ₋₁(v) is a criticality evaluation value obtained after the (t−1)^{th} iteration, p(uᵢ→v) is a value of a correlation between candidate key social information uᵢ associated with the candidate key social information v and the candidate key social information v, and

$${Z}_{t - 1} ( u ) = {\sum }_{i = 0}^{i = n} p ( {u}_{i} \to v ) {R}_{t - 1} ( v ) .$$

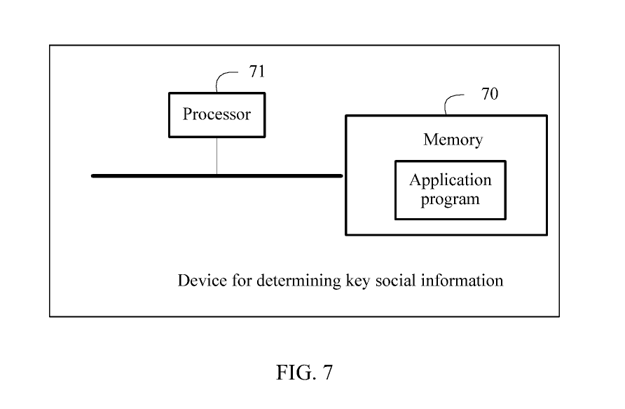

Based on the foregoing technical solution, referring to FIG. 7, an embodiment of the present disclosure provides a device for determining key social information, including a memory 70 and a processor 71.

The memory 70 is configured to store an application program.

The processor 71 is configured to run the application program stored in the memory 70, so as to perform the following operations: generate a social information retransmitting tree according to to-be-determined original social information and retransmitted social information of the original social information, where the retransmitted social information comprising information indicating directly or indirectly retransmission of the original social information, the social information retransmitting tree is of a tree-like structure, the original social information is a root node in the tree-like structure, and the retransmitted social information is a leaf node in the tree-like structure and an intermediate node between the root node and the leaf node; acquire a characteristic vector of each piece of retransmitted social information according to an information characteristic of each piece of retransmitted social information, where the information characteristic includes a text characteristic and a characteristic associated with the social information retransmitting tree, and the character vector of each piece of retransmitted social information includes a vector that represents the text characteristic of the retransmitted social information and a vector that represents the characteristic that is of the retransmitted social information and that is associated with the social information retransmitting tree; input the acquired characteristic vector of each piece of retransmitted social information into a preset filtering model, and acquire candidate key social information included in all retransmitted social information; calculating a criticality evaluation value corresponding to each acquired candidate key social information; and select a preset amount of candidate key social information in descending order of criticality evaluation values from all candidate key social information obtained by means of calculation, and determine the selected candidate key social information as the key social information.

Optionally, the processor 71 is configured to perform the following operations for any piece of retransmitted social information in the social information retransmitting tree: extracting a text characteristic of the any piece of retransmitted social information from content of the any piece of retransmitted social information, converting each characteristic amount included in the text characteristic of the any piece of retransmitted social information into a characteristic amount in a numerical value form by using a preset algorithm, and acquiring, according to all characteristic amounts in a numerical value form, a text characteristic vector corresponding to the any piece of retransmitted social information; acquiring, according to location information of a node represented by the any piece of retransmitted social information in the social information retransmitting tree and/or a quantity of nodes in the social information retransmitting tree that are brother nodes of the node represented by the any piece of retransmitted social information, a characteristic vector that is corresponding to the any piece of retransmitted social information and associated with the social information retransmitting tree; and combining the text characteristic vector and the characteristic vector associated with the social information retransmitting tree, to acquire a characteristic vector of the any piece of retransmitted social information, where the combination processing is performing up-and-down combination on the text characteristic vector and the characteristic vector associated with the social information retransmitting tree, or performing left-and-right combination on the text characteristic vector and the characteristic vector associated with the social information retransmitting tree.

Further, the processor 71 is configured to acquire training retransmitted social information of any piece of training original social information from historical data; generate a characteristic vector of each piece of training retransmitted social information according to an information characteristic of each piece of training retransmitted social information, where the characteristic vector of each piece of training retransmitted social information includes a vector that represents a text characteristic of the training retransmitted social information and a vector that represents a characteristic that is of the training retransmitted social information and that is associated with the social information retransmitting tree; acquire a filtering parameter by using a preset filtering algorithm according to the characteristic vector of each piece of training retransmitted social information and a known filtering and classification result of each piece of training retransmitted social information; and generate the filtering model according to the filtering parameter.

Further, the processor 71 is configured to acquire the filtering parameter by using a support vector machine algorithm according to the characteristic vector of each piece of training retransmitted social information and the known filtering and classification result of each piece of training retransmitted social information; or acquire the filtering parameter by using a perceptron neural network algorithm according to the characteristic vector of each piece of training retransmitted social information and the known filtering and classification result of each piece of training retransmitted social information; or generate an input sequence according to the characteristic vector of each piece of training retransmitted social information and a retransmitting relationship between the pieces of training retransmitted social information, generate an output sequence according to the known filtering and classification result of each piece of training retransmitted social information, establish a correlation function between the input sequence and the output sequence, determine a parameter of the correlation function according to the known filtering and classification result of each piece of training retransmitted social information, and determine the parameter as the filtering parameter.

Optionally, the processor 71 is configured to establish a table of a link relationship between the input sequence and the output sequence according to a retransmitting relationship between characteristic vectors included in the input sequence and a relationship between each characteristic vector included in the input sequence and each filtering and classification result included in the output sequence; and perform the following operations for any characteristic vector in the input sequence: scanning the table of the link relationship by using a window of a preset width, where a currently scanned window includes the any vector, generating a first partial correlation function according to a filtering and classification result in the output sequence and the any characteristic vector that are included in the currently scanned window, and generating a second partial correlation function according to the filtering and classification result in the output sequence that is included in the currently scanned window; and establishing the correlation function between the input sequence and the output sequence according to a first partial correlation function and a second partial correlation function that are corresponding to each vector included in the input sequence.

Optionally, the processor 71 is configured to construct a candidate key social information diagram according to the candidate key social information, where the key social information diagram includes all the candidate key social information, and every two pieces of candidate key social information are connected to each other; and for any piece of candidate key social information in the candidate key social information diagram, acquire a value of a correlation between the any piece of candidate key social information and each of other pieces of candidate key social information, and determine, according to the value of the correlation between the any piece of candidate key social information and each of the other pieces of candidate key social information in the candidate key social information diagram, a criticality evaluation value corresponding to the any piece of candidate key social information.

Optionally, the criticality evaluation value obtained by the processor 71 by means of calculation meets the following formula:

$${R}_{t} ( v ) = λ {R}_{0} ( v ) + ( 1 - λ ) {\sum }_{i = 0}^{i = n} \frac{p ( {u}_{i} \to v ) {R}_{t - 1} ( v )}{{Z}_{t - 1} ( u )} ,$$

where Rₜ(v) is a criticality evaluation value obtained after the t^{th} iteration, λ is a preset coefficient, R₀(v) is a quantity of times candidate key social information v is retransmitted, n is a quantity of candidate key social information associated with the candidate key social information v in the candidate key social information diagram, Rᵢ₋₁(v) is a criticality evaluation value obtained after the (t−1)^{th} iteration, p(uᵢ→v) is a value of a correlation between candidate key social information uᵢ associated with the candidate key social information v and the candidate key social information v, and

$${Z}_{t - 1} ( u ) = {\sum }_{i = 0}^{i = n} p ( {u}_{i} \to v ) {R}_{t - 1} ( v ) .$$

In conclusion, a social information retransmitting tree is generated according to to-be-tested original social information and retransmitted social information of the original social information, where the retransmitted social information comprising information indicating directly or indirectly retransmission of the original social information, the social information retransmitting tree is of a tree-like structure, the original social information is a root node in the tree-like structure, and the retransmitted social information is a leaf node in the tree-like structure and an intermediate node; a characteristic vector of each piece of retransmitted social information is acquired according to an information characteristic of each piece of retransmitted social information in the social information retransmitting tree, where the information characteristic includes a text characteristic and a characteristic associated with the social information retransmitting tree; the characteristic vector of each piece of retransmitted social information is input into a preset filtering model, and candidate key social information included in all retransmitted social information is acquired; a criticality evaluation value corresponding to each piece of candidate key social information is calculated; a preset amount of candidate key social information in descending order of criticality evaluation values is selected from all candidate key social information, and the selected candidate key social information is determined as key social information. In the technical solution of the present disclosure, directly-retransmitted social information and indirectly-retransmitted social information are comprehensively considered, and key social information is selected from all retransmitted social information of original social information, which avoids a problem of a one-sided selection result that is caused when key social information is selected only from directly-retransmitted social information, and improves accuracy of a selection result. In addition, in a process of selecting the key social information, content of retransmitted social information and a characteristic associated with a social information retransmitting tree are used as reference factors, which further improves the accuracy of the final selection result.

Persons skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a compact disc read-only memory (CD-ROM), an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some exemplary embodiments of the present disclosure have been described, persons skilled in the art can make changes and modifications to these embodiments once they learn the basic inventive concept. Therefore, the following claims are intended to be construed as to cover the exemplary embodiments and all changes and modifications falling within the scope of the present disclosure.

Obviously, persons skilled in the art can make various modifications and variations to the embodiments of the present disclosure without departing from the spirit and scope of the embodiments of the present disclosure. The present disclosure is intended to cover these modifications and variations provided that they fall within the scope of protection defined by the following claims and their equivalent technologies.

What is claimed is:

1. A method for determining key social information, comprising:
generating a social information retransmitting tree according to to-be-determined original social information and retransmitted social information of the original social information, wherein the retransmitted social information comprises information indicating directly or indirectly retransmission of the original social information, wherein the social information retransmitting tree is of a tree-like structure, wherein the original social information is a root node in the tree-like structure, and wherein the retransmitted social information is a leaf node in the tree-like structure and an intermediate node between the root node and the leaf node;
acquiring a characteristic vector of each piece of retransmitted social information according to an information characteristic of each piece of retransmitted social information, wherein the information characteristic comprises a text characteristic and a characteristic associated with the social information retransmitting tree, and wherein the character vector of each piece of retransmitted social information comprises a vector that represents the text characteristic of the retransmitted social information and a vector that represents the characteristic that is of the retransmitted social information and that is associated with the social information retransmitting tree;
inputting the characteristic vector of each piece of retransmitted social information into a preset filtering model;
acquiring candidate key social information comprised in all retransmitted social information;
calculating a criticality evaluation value corresponding to each piece of candidate key social information;
selecting a preset amount of candidate key social information in descending order of criticality evaluation values from all candidate key social information; and
determining the selected candidate key social information as the key social information.

2. The method according to claim 1, wherein acquiring the characteristic vector of each piece of retransmitted social information according to the information characteristic of each piece of retransmitted social information comprises performing the following operations for any piece of retransmitted social information in the social information retransmitting tree:
extracting a text characteristic of any piece of the retransmitted social information from content of the any piece of retransmitted social information, converting each characteristic amount comprised in the text characteristic of the any piece of retransmitted social information into a characteristic amount in a numerical value form by using a preset algorithm, and acquiring, according to all characteristic amounts in a numerical value form, a text characteristic vector corresponding to the any piece of retransmitted social information;
acquiring, according to location information of a node represented by the any piece of retransmitted social information in the social information retransmitting tree and/or a quantity of nodes in the social information retransmitting tree that are brother nodes of the node represented by the any piece of retransmitted social information, a characteristic vector that is corresponding to the any piece of retransmitted social information and associated with the social information retransmitting tree; and
combining the text characteristic vector and the characteristic vector associated with the social information retransmitting tree, to acquire a characteristic vector of the any piece of retransmitted social information, wherein the combination processing is performing up-and-down combination on the text characteristic vector and the characteristic vector associated with the social information retransmitting tree, or performing left-and-right combination on the text characteristic vector and the characteristic vector associated with the social information retransmitting tree.

3. The method according to claim 1, wherein a method for generating the filtering model comprises:
acquiring training retransmitted social information of any piece of training original social information from historical data;
generating a characteristic vector of each piece of training retransmitted social information according to an information characteristic of each piece of training retransmitted social information, wherein the characteristic vector of each piece of training retransmitted social information comprises a vector that represents a text characteristic of the training retransmitted social information and a vector that represents a characteristic that is of the training retransmitted social information and that is associated with the social information retransmitting tree;
acquiring a filtering parameter by using a preset filtering algorithm according to the characteristic vector of each piece of training retransmitted social information and a known filtering and classification result of each piece of training retransmitted social information; and
generating the filtering model according to the filtering parameter.

4. The method according to claim 2, wherein acquiring the filtering parameter by using the preset filtering algorithm according to the characteristic vector of each piece of training retransmitted social information and the known filtering and classification result of each piece of training retransmitted social information comprises acquiring the filtering parameter by using a support vector machine algorithm according to the characteristic vector of each piece of training retransmitted social information and the known filtering and classification result of each piece of training retransmitted social information.

5. The method according to claim 2, wherein acquiring the filtering parameter by using the preset filtering algorithm according to the characteristic vector of each piece of training retransmitted social information and the known filtering and classification result of each piece of training retransmitted social information comprises acquiring the filtering parameter by using a perceptron neural network algorithm according to the characteristic vector of each piece of training retransmitted social information and the known filtering and classification result of each piece of training retransmitted social information.

6. The method according to claim 2, wherein acquiring the filtering parameter by using the preset filtering algorithm according to the characteristic vector of each piece of training retransmitted social information and the known filtering and classification result of each piece of training retransmitted social information comprises generating an input sequence according to the characteristic vector of each piece of training retransmitted social information and a retransmitting relationship between the pieces of training retransmitted social information, generating an output sequence according to the known filtering and classification result of each piece of training retransmitted social information, establishing a correlation function between the input sequence and the output sequence, determining a parameter of the correlation function according to the known filtering and classification result of each piece of training retransmitted social information, and determining the parameter as the filtering parameter.

7. The method according to claim 6, wherein establishing the correlation function between the input sequence and the output sequence comprises:
establishing a table of a link relationship between the input sequence and the output sequence according to a retransmitting relationship between characteristic vectors comprised in the input sequence and a relationship between each characteristic vector comprised in the input sequence and each filtering and classification result comprised in the output sequence;
performing the following operations for any characteristic vector in the input sequence: scanning the table of the link relationship by using a window of a preset width, wherein a currently scanned window comprises the characteristic vector, generating a first partial correlation function according to a filtering and classification result in the output sequence and the any characteristic vector that are comprised in the currently scanned window, and generating a second partial correlation function according to the filtering and classification result in the output sequence that is comprised in the currently scanned window; and
establishing the correlation function between the input sequence and the output sequence according to a first partial correlation function and a second partial correlation function that are corresponding to each characteristic vector comprised in the input sequence.

8. The method according to claim 1, wherein calculating the criticality evaluation value corresponding to each piece of candidate key social information comprises:
constructing a candidate key social information diagram according to the candidate key social information, wherein the candidate key social information diagram comprises all the candidate key social information, and wherein every two pieces of candidate key social information are connected to each other; and
for any piece of candidate key social information in the candidate key social information diagram, acquiring a value of a correlation between the any piece of candidate key social information and each of other pieces of candidate key social information, and determining, according to the value of the correlation between the any piece of candidate key social information and each of the other pieces of candidate key social information in the candidate key social information diagram, a criticality evaluation value corresponding to the any piece of candidate key social information.

9. The method according to claim 8, wherein the criticality evaluation value meets the following formula:
$${R}_{t} ( v ) = λ {R}_{0} ( v ) + ( 1 - λ ) {\sum }_{i = 0}^{i = n} \frac{p ( {u}_{i} \to v ) {R}_{t - 1} ( v )}{{Z}_{t - 1} ( u )} ,$$
wherein Rₜ(v) is a criticality evaluation value obtained after the t^{th} iteration, λ is a preset coefficient, R₀(v) is a quantity of times candidate key social information v is retransmitted, n is a quantity of candidate key social information associated with the candidate key social information v in the candidate key social information diagram, Rᵢ₋₁(v) is a criticality evaluation value obtained after the (t−1)^{th} iteration, p(uᵢ→v) is a value of a correlation between candidate key social information uᵢ associated with the candidate key social information v and the candidate key social information v, and
$${Z}_{t - 1} ( u ) = {\sum }_{i = 0}^{i = n} p ( {u}_{i} \to v ) {R}_{t - 1} ( v ) .$$

10. An apparatus for determining key social information, comprising:
a non-transitory computer readable medium having instructions stored thereon; and
a computer processor coupled to the non-transitory computer readable medium and configured to execute the instructions to:
generate a social information retransmitting tree according to to-be-determined original social information and retransmitted social information of the original social information, wherein the retransmitted social information comprises information indicating directly or indirectly retransmission of the original social information, wherein the social information retransmitting tree is of a tree-like structure, wherein the original social information is a root node in the tree-like structure, and wherein the retransmitted social information is a leaf node in the tree-like structure and an intermediate node between the root node and the leaf node;
acquire a characteristic vector of each piece of retransmitted social information according to an information characteristic of each piece of retransmitted social information, wherein the information characteristic comprises a text characteristic and a characteristic associated with the social information retransmitting tree, and wherein the character vector of each piece of retransmitted social information comprises a vector that represents the text characteristic of the retransmitted social information and a vector that represents the characteristic that is of the retransmitted social information and that is associated with the social information retransmitting tree;
input, into a preset filtering model, the characteristic vector that is of each piece of retransmitted social information; and
acquire candidate key social information comprised in all retransmitted social information;
calculate a criticality evaluation value corresponding to each piece of candidate key social information;
select a preset amount of candidate key social information in descending order of criticality evaluation values from all candidate key social information according to the criticality evaluation value that is corresponding to each piece of candidate key social information and that is obtained by means of calculation; and
determine the selected candidate key social information as the key social information.

11. The apparatus according to claim 10, wherein the computer processor is configured to execute the instructions to perform the following operations for any piece of retransmitted social information in the social information retransmitting tree:
extract a text characteristic of the any piece of retransmitted social information from content of the any piece of retransmitted social information, convert each characteristic amount comprised in the text characteristic of the any piece of retransmitted social information into a characteristic amount in a numerical value form by using a preset algorithm, and acquire, according to all characteristic amounts in a numerical value form, a text characteristic vector corresponding to the any piece of retransmitted social information;
acquire, according to location information of a node represented by the any piece of retransmitted social information in the social information retransmitting tree and/or a quantity of nodes in the social information retransmitting tree that are brother nodes of the node represented by the any piece of retransmitted social information, a characteristic vector that is corresponding to the any piece of retransmitted social information and associated with the social information retransmitting tree; and
combine the text characteristic vector and the characteristic vector associated with the social information retransmitting tree, to acquire a characteristic vector of the any piece of retransmitted social information, wherein the combination processing is performing up-and-down combination on the text characteristic vector and the characteristic vector associated with the social information retransmitting tree, or performing left-and-right combination on the text characteristic vector and the characteristic vector associated with the social information retransmitting tree.

12. The apparatus according to claim 10, wherein the computer processor is configured to execute the instructions to acquire training retransmitted social information of any piece of training original social information from historical data;
generate a characteristic vector of each piece of training retransmitted social information according to an information characteristic of each piece of training retransmitted social information, wherein the characteristic vector of each piece of training retransmitted social information comprises a vector that represents a text characteristic of the training retransmitted social information and a vector that represents a characteristic that is of the training retransmitted social information and that is associated with the social information retransmitting tree;
acquire a filtering parameter by using a preset filtering algorithm according to the characteristic vector of each piece of training retransmitted social information and a known filtering and classification result of each piece of training retransmitted social information; and
generate the filtering model according to the filtering parameter.

13. The apparatus according to claim 11, wherein that the computer processor is configured to execute the instructions to acquire the filtering parameter by using the preset filtering algorithm according to the characteristic vector of each piece of training retransmitted social information and the known filtering and classification result of each piece of training retransmitted social information comprises acquiring the filtering parameter by using a support vector machine algorithm according to the characteristic vector of each piece of training retransmitted social information and the known filtering and classification result of each piece of training retransmitted social information.

14. The apparatus according to claim 11, wherein that the computer processor is configured to execute the instructions to acquire the filtering parameter by using the preset filtering algorithm according to the characteristic vector of each piece of training retransmitted social information and the known filtering and classification result of each piece of training retransmitted social information comprises acquiring the filtering parameter by using a perceptron neural network algorithm according to the characteristic vector of each piece of training retransmitted social information and the known filtering and classification result of each piece of training retransmitted social information.

15. The apparatus according to claim 11, wherein that the computer processor is configured to execute the instructions to acquire the filtering parameter by using the preset filtering algorithm according to the characteristic vector of each piece of training retransmitted social information and the known filtering and classification result of each piece of training retransmitted social information comprises generating an input sequence according to the characteristic vector of each piece of training retransmitted social information and a retransmitting relationship between the pieces of training retransmitted social information, generating an output sequence according to the known filtering and classification result of each piece of training retransmitted social information, establishing a correlation function between the input sequence and the output sequence, determine a parameter of the correlation function according to the known filtering and classification result of each piece of training retransmitted social information, and determine the parameter as the filtering parameter.

16. The apparatus according to claim 15, wherein that the computer processor is configured to execute the instructions to establish the correlation function between the input sequence and the output sequence comprises:
establishing a table of a link relationship between the input sequence and the output sequence according to a retransmitting relationship between characteristic vectors comprised in the input sequence and a relationship between each characteristic vector comprised in the input sequence and each filtering and classification result comprised in the output sequence; and
performing the following operations for any characteristic vector in the input sequence:
scan the table of the link relationship by using a window of a preset width, wherein a currently scanned window comprises the any vector, generating a first partial correlation function according to a filtering and classification result in the output sequence and the any characteristic vector that are comprised in the currently scanned window, and generate a second partial correlation function according to the filtering and classification result in the output sequence that is comprised in the currently scanned window; and
establish the correlation function between the input sequence and the output sequence according to a first partial correlation function and a second partial correlation function that are corresponding to each vector comprised in the input sequence.

17. The apparatus according to claim 10, wherein the computer processor is configured to execute the instructions to:
construct a candidate key social information diagram according to the candidate key social information, wherein the key social information diagram comprises all the candidate key social information, and wherein every two pieces of candidate key social information are connected to each other; and
for any piece of candidate key social information in the candidate key social information diagram, acquire a value of a correlation between the any piece of candidate key social information and each of other pieces of candidate key social information, and determine, according to the value of the correlation between the any piece of candidate key social information and each of the other pieces of candidate key social information in the candidate key social information diagram, a criticality evaluation value corresponding to the any piece of candidate key social information.

18. The apparatus according to claim 17, wherein the criticality evaluation value obtained by means of calculation meets the following formula:
$${R}_{t} ( v ) = λ {R}_{0} ( v ) + ( 1 - λ ) {\sum }_{i = 0}^{i = n} \frac{p ( {u}_{i} \to v ) {R}_{t - 1} ( v )}{{Z}_{t - 1} ( u )} ,$$
wherein Rₜ(v) is a criticality evaluation value obtained after the t^{th} iteration, λ is a preset coefficient, R₀(v) is a quantity of times candidate key social information v is retransmitted, n is a quantity of candidate key social information associated with the candidate key social information v in the candidate key social information diagram, Rᵢ₋₁(v) is a criticality evaluation value obtained after the (t−1)^{th} iteration, p(uᵢ→v) is a value of a correlation between candidate key social information uᵢ associated with the candidate key social information v and the candidate key social information v, and
$${Z}_{t - 1} ( u ) = {\sum }_{i = 0}^{i = n} p ( {u}_{i} \to v ) {R}_{t - 1} ( v ) .$$
